(19) United States
(12) Patent Application Publication
(10) Pub. No.: US 2010/0065666 A1
(43) Pub. Date: Mar. 18, 2010

(54) WATER ECONOMISER WITH MANUAL IMPULSE CONTROL TO BE MOUNTED ON A TAP SPOUT

(76) Inventor: Daniel Savonnet, Saint-Andre-Les-Vergers (FR)

Correspondence Address: YOUNG & THOMPSON, 209 Madison Street, Suite 500, Alexandria, VA, 22314, US

(21) Appl. No.: 12/447,386

(22) PCT Filed: Oct. 26, 2007
(86) PCT No.: PCT/FR07/01772

§ 371 Date: Jul. 13, 2009

(30) Foreign Application Priority Data
Oct. 27, 2006 (FR) 0609442

(51) Int. Cl. E03C 1/08; B05B 1/30

(52) U.S. Cl. 239/583; 137/801

(57) ABSTRACT

A water economizer (1) to be mounted on a tap spout through which water flows at an adjusted flow-rate when the tape is open, includes a flow-rate reduction or interruption mechanical device, a water inlet pipe (5) fitted on the tap spout, an outlet pipe (7) for discharging the water out of the economizer, the inlet and outlet pipes defining a flow axis (9). The economizer includes a pulse control device for reducing or interrupting the water flow when the tap is open and when a first pulse is applied from the top to the bottom on the outlet pipe along the flow axis, and for restoring the initially adjusted water flow when a second pulse similar to the first pulse is applied from the top to the bottom on the outlet pipe. The comfort of the device advantageously makes it attractive to use and efficient against water waste.

The present invention relates to a water economiser to be mounted on a tap spout, from which water flows at a rate and temperature generally defined by means of hot-water and cold-water control levers.

Taps are mainly used for hygiene purposes, for example for washing fruit and vegetables before consumption, for washing hands, or for doing washing up after use. This represents approximately sixty percent of the domestic consumption of hot or cold water. Normally, when opening the tap, the user unconsciously has a tendency to adjust to a high water flow rate. Next, said user generally finds it inconvenient to close the tap for a short instant, all the more so if he has soapy hands or hands encumbered by dishes, and the temperature of the water initially adjusted would be modified when reopening the tap. As a result water flows unnecessarily for more than fifty percent of the time, giving rise to a significant waste of water.

For this purpose economisers are known that make it possible to reduce the flow rate of water during use. This type of economiser is composed of a water inlet pipe fixed to the tap outlet spout and a water outlet pipe through which the water is discharged out of the economiser. This type of economiser comprises a flow rate reduction device that makes it possible to limit the flow rate leaving the economiser instantaneously, as soon as the tap as opened, and thus to routinely compensate for any unwanted adjustment of flow rate with the tap control levers. These economisers certainly provide a reduction in the water flow rate, but for all that do not prevent the flow of water while the user is soaping his hands or cleaning food or crockery, before rinsing.

Other embodiments of a water economiser are also known, comprising an inlet pipe, an outlet pipe and a mechanical flow rate reduction or interruption device. This device is provided with a control lever with two positions, manoeuvred manually by rotation or translation, making it possible to position said handle alternately in a first position or in a second position, the first position reducing or interrupting the flow rate and the second position re-establishing the flow rate as adjusted with the tap control levers. The patent GB 2 356 687 describes an example embodiment of a device of this type, the control lever functioning by translation. This design requires manipulating the control lever with dirty hands or hands covered with detergent, which dirties said lever.

The present invention aims to remedy the drawbacks of current economisers by proposing a novel economiser design, which can be manipulated easily and either reduces or interrupts the flow rate or re-establishes it as adjusted initially with the tap control levers, by a simple impulse on the economiser.

To this end, the invention concerns a water economiser for mounting on a tap spout, through which the water flows at a rate adjusted when the tap is opened, the said economiser comprising a mechanical flow rate reduction or interruption device, a water inlet pipe mounted on the tap spout, and an outlet pipe through which the water is discharged out of the economiser, said inlet and outlet pipes defining a flow axis. The economiser is remarkable in that it comprises an impulse control device making it possible, when the tap is open and when a first impulse is exerted upwards on the outlet pipe along the flow axis, to reduce or interrupt the flow of water, and then, when a second impulse is exerted upwards on the outlet pipe, similar to the first impulse, to re-establish the water flow rate as initially adjusted.

The economiser according to the invention has the advantage of allowing the reduction or interruption of the flow rate, very easily, by a simple impulse exerted upwards on the outlet pipe, this impulse being able to be achieved with the back of the hand, the palm of the hand, a finger or the fist. In addition, any dirt or detergent deposited on the outlet pipe during an impulse is systematically rinsed from this outlet pipe when the water flow resumes.

Other advantages will emerge during the following description based on figures showing a design of the economiser according to the invention, including:

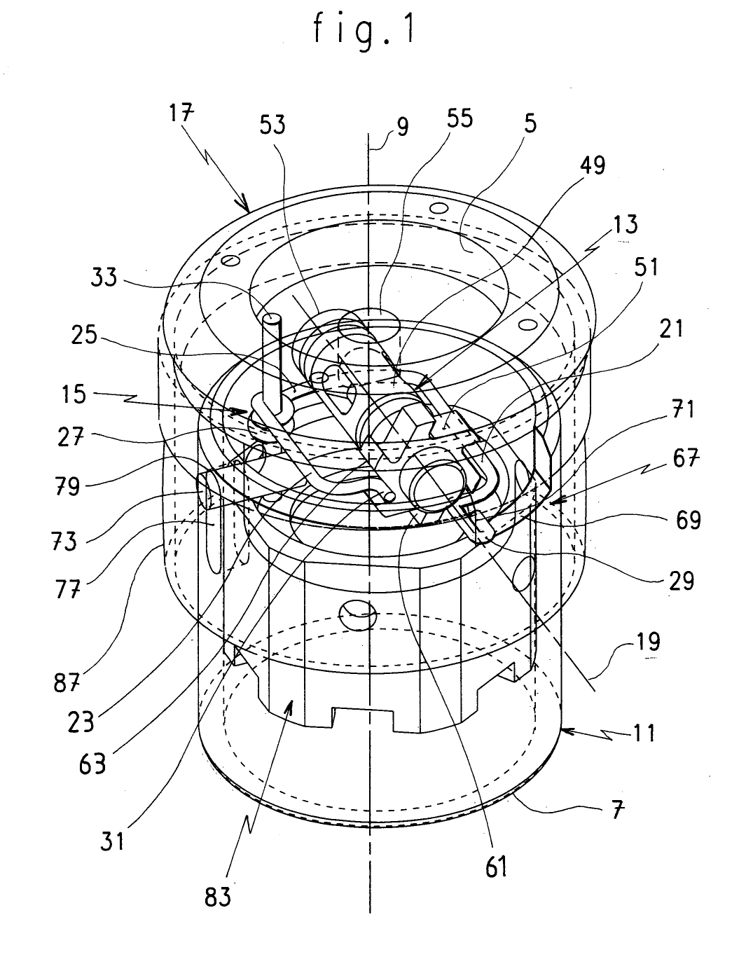

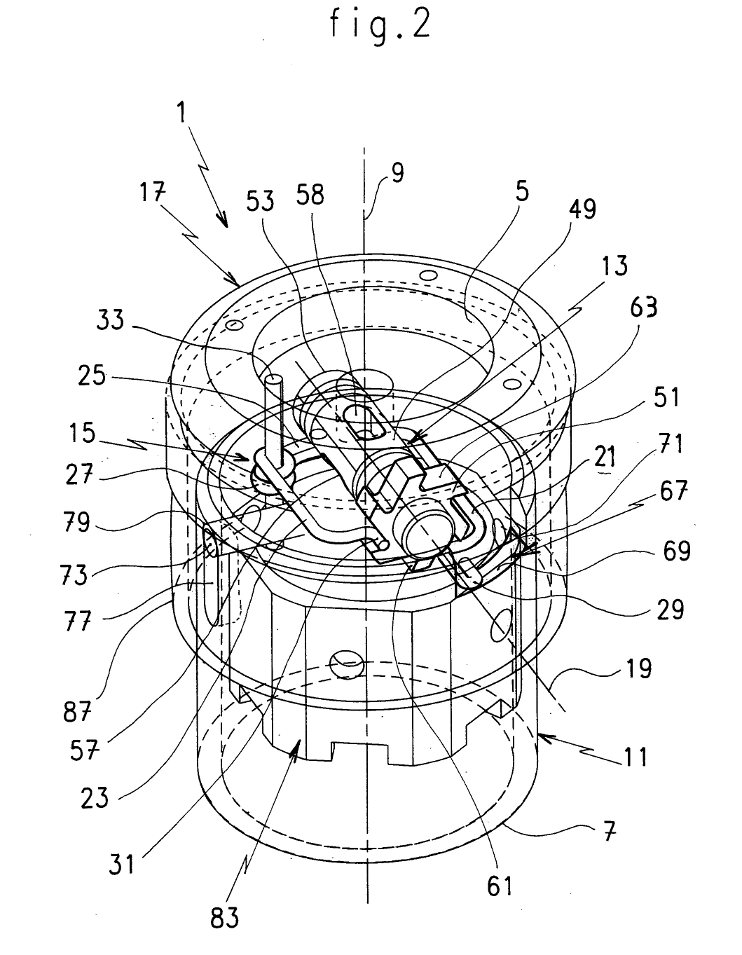

FIGS. 1 and 2 depict two overall views of the economiser, FIG. 1 showing the economiser in a position in which the flow rate is normal and FIG. 2 showing the economiser in a position in which the flow rate is reduced or interrupted,

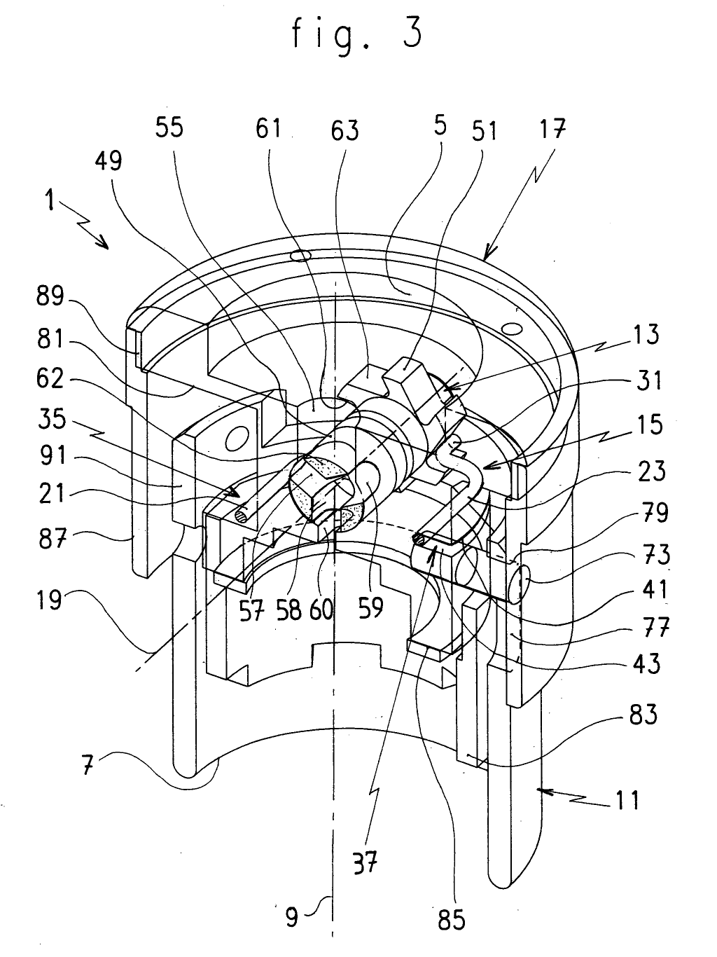

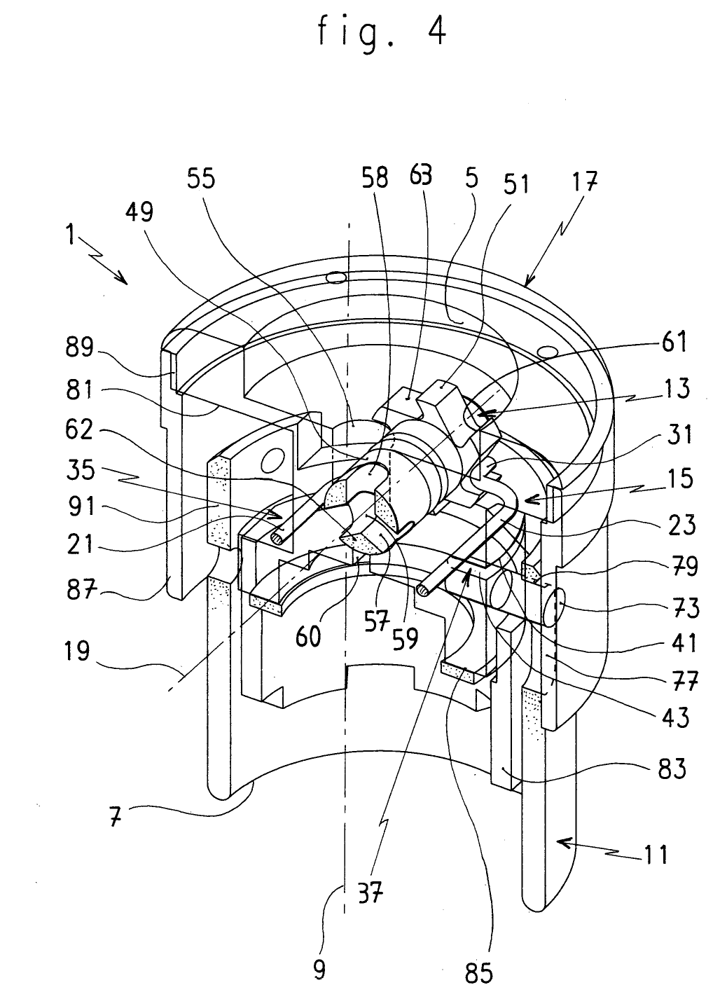

FIGS. 3 and 4 show two views in section and in three dimensions of the economiser according to FIGS. 1 and 2, FIG. 3 showing the economiser in a normal flow rate position and FIG. 4 showing the economiser in a position in which the flow rate is reduced or interrupted,

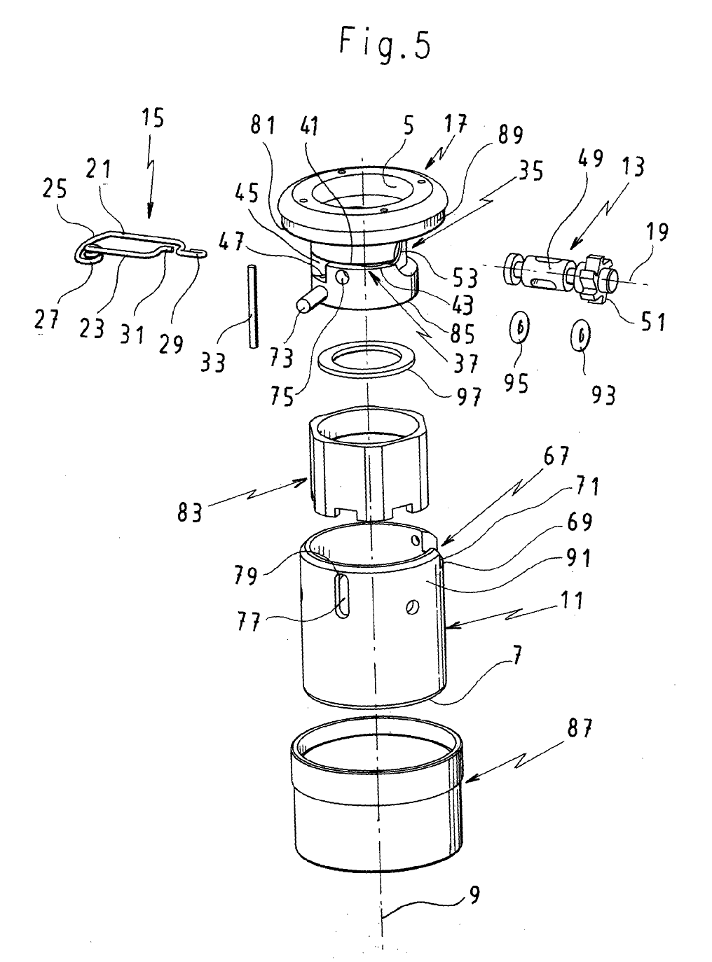

FIG. 5 shows an exploded view in three dimensions of the economiser according to FIGS. 1 to 4.

With reference to all of the figures, the water economiser 1 according to the invention can be mounted on the spout of a tap. The user actuates the tap control levers (not shown in the figures) to open or close the flow of water. When the tap is open, the water flows through the tap spout at a flow rate adjusted by means of the control levers, which also regulate the temperature, this water then entering the economiser 1 connected to said tap spout. The economiser 1 comprises an inlet pipe 5 mounted on the tap spout, in which the water enters at the flow rate as adjusted initially with the levers. The economiser 1 also comprises an outlet pipe 7 through which the water is discharged in order to be used. These inlet 5 and outlet 7 pipes define a flow channel having a flow axis 9, which is preferably merged with the axis of the tap spout when the economiser 1 is fixed to said spout. This flow axis 9 is generally defined along the vertical or slightly inclined with respect to the vertical, so as to take advantage of the action of gravity on the parts making up said economiser, as will be described below.

The economiser 1 according to the invention is remarkable in that it comprises an impulse-type control device arranged between the inlet pipe 5 and the outlet pipe 7, which comprises at least one pusher 11, a rotary valve 13, an incrementation spring 15 and a body 17.

The pusher 11 is the element of the economiser 1 on which the impulses are exerted upwards, either to reduce or interrupt the flow of water or to re-establish normal flow. This pusher 11 is arranged at the bottom part of the impulse device, in the flow axis 9. Preferentially, the pusher 11 is tubular in shape and its bottom end constitutes the outlet pipe 7 of the economiser 1.

The rotary valve 13 is of the incrementation type, that is to say it makes, at each impulse given on the pusher 11, a rotation with a regular pitch about an axis perpendicular to the flow axis 9. According to its incrementation position, the rotary valve 13 allows either the reduction or the interruption of the flow, or change to the normal flow initially adjusted.

The spring 15 allows incrementation of the rotary valve 13 when an impulse is given on the pusher 11. The pusher 11 actuates the spring 15, which drives the rotation of the valve 13. This spring 15 next contributes to the return of the pusher 11 to its position, so that the user can effect a new impulse and modify the state of operation of the economiser 1.

The body 17 receives the incrementation spring 15 and the rotary valve 13. The pusher 11 is mounted so as to slide with respect to the body 17, along the flow axis 9. Preferentially, the body 17 is tubular in shape and its top end constitutes the inlet pipe 5 of the economiser 1 in which the water leaving the tap spout enters. The top end of the body 17 has a thread enabling it to be screwed to the tap spout. Advantageously, the economiser will comprise a thread adapter, not shown, that thus makes it possible to mount the economiser at the end of any type of tap whatever their thread, male or female.

According to the variant design shown in FIGS. 1 to 5, the incrementation spring 15 is in the shape of a U comprising two arms 21, 23 and a base 25. The first arm 21 is situated in line with the base 25, while the spring comprises a loop 27 in the form of spiral disposed between the second arm 23 and the base 25; this loop 27 improves the elastic properties of the spring 15 for return of the arms 21, 23 to their position when they are deformed. The ends 29, 31 of the arms 21, 23 of the spring 15 are curved so that, when the spring 15 contracts, its ends 29, 31 exhibit a separation enabling them to cooperate with the rotary valve 13, as will be described below.

The spring 15 is held flat on the body 17 and is mounted in pivot connection on said body 17 by means of a pivoting piece 33 that receives the loop 27 of this spring 15, as shown in FIGS. 1, 2 and 4. This holding flat and mounting pivot connection are arranged to allow translation of the first of the arms 21 of the U in the direction of the flow axis 9 and upwards, that is to say towards the spout of the tap 3 when there is an impulse on the pusher 11, and then its return to its position; they also make it possible to pivot the two arms 21, 23 of the U while holding them flat on the body 17, the second of the arms 23 undergoing a rotation with respect to the pivoting piece 33 during an incrementation of the rotary valve 13.

This incrementation of the rotary valve 13 is obtained during an impulse exerted on the pusher 11 which translates the first arm 21, this translation driving the rotary valve 13 in rotation about its axis 19.

Holding the U-shaped spring 15 flat locks the second arm 23 in translation with respect to the body 17 in both directions of the flow axis 9. The function of this locking is to ensure the elastic return of the first arm 21 to the idle position; this return to the idle position and the tension exerted by said first arm 21 allow the repositioning of the pusher 11 in the initial position after having effected an impulse on it. Preferentially, the first arm continuously exerts a bearing pressure on the pusher in order to ensure its return and holding in the low position.

With reference to FIGS. 3 to 5, the body 17 comprises two housings 35, 37 for holding the spring 15 flat. The first housing 35 is arranged to receive the first arm 21 of the spring 15, leaving it free in upward translation so as to allow its to and fro movement when an impulse is exerted on the pusher 11. The second housing 37 is arranged to receive the second arm 23 of the spring 15, locking it in both directions of the flow axis 9. This housing 37 has dimensions corresponding to those of the second arm 23 so that the latter is locked by the top face 41 and the bottom face 43 of the said housing 37. The spring 15 is therefore inserted on the body 17, placing the arms 21, 23 respectively in the housing 35, 37, while the spiral loop 25 for its part is inserted in a third housing 45 and then held in position by the pivoting piece 33, which is inserted in an orifice 47 on the body 17, shown in FIG. 5, thus ensuring that it is held in position.

With reference to FIG. 5, the variant embodiment shown of the rotary valve 13 comprises a cylindrical central body 49 and teeth 51 for incrementing said cylindrical central body 49 in rotation about the axis 19 perpendicular to the flow axis 9. For this purpose, the body 17 comprises a cylindrical housing 53 to the corresponding dimensions, defined along the axis 19, and which receives the cylindrical body 49 of the valve 13, thus providing its mounting as a pivot connection on said body 17, along the axis 19.

With reference to FIGS. 1 to 4, the cylindrical housing 53 on the body 17 communicates with the flow channel 55. The rotary valve 13 comprises at least three apertures 57, 58, 59 disposed in a radial position and uniformly distributed over 360° around the central body, cylindrical in the variant shown. These apertures 57, 58, also communicate with the flow channel 55 when the cylindrical central body 49 is in position in the cylindrical housing 53 of the body 17, thus providing either the reduction or the interruption of the flow of water, or the free passage of the flow of water, according to the rotational incrementation of the valve 13. This is because, at a first impulse, the valve 13 increments and makes a rotation by positioning itself as shown in FIG. 1, the apertures 57, 58, 59 then communicating with the flow channel 55 in order to provide the normal flow of the tap as shown in FIGS. 1 and 3. According to these FIGS. 1 and 3, the apertures 57 and 59 communicate with the inlet of the flow channel and the aperture 58 communicates with the outlet 60 of the flow channel, this outlet 60 constituting the outflow whose shape corresponds to that of the apertures 57, 58, on the valve 13. At a second impulse, the valve 13 makes an incrementation of ⅙ of a turn and positions itself as shown in FIGS. 2 and 4; the aperture 58 then communicates with the inlet of the flow channel and the outlet 60 of the channel is obstructed by the material formed by the solid part 62 between the apertures 57, 59, thus reducing the flow from the tap. In this position shown in FIGS. 2 and 4, the water exerts a pressure on the solid part between the apertures 57, 59; this pressure presses the valve on the exhaust outlet 60. This solid part 62 disposed between the apertures 57, 59 can however completely close off the flow channel 55, in a configuration similar to FIGS. 2 and 4, and in this case reduce the flow to a drip at the second impulse. Naturally it is possible to add seals in order to interrupt the flow completely.

According to another variant embodiment of the rotary valve 13, not shown in the figures, it will advantageously comprise a spherically shaped central body.

This design facilitates the rotational driving of the valve 13 and obtains a superior seal compared with the cylindrical variant embodiment of the central body 49 of said valve 13. This is because a seal will advantageously be positioned at the periphery of the top end of the outlet 60 of the flow channel 55, between the body of the valve and the housing 53 of the body 17, which will have a recess for receiving said seal. Through its spherical shape, the pressure of the water exerted on the valve 13 is distributed over the periphery of the orifice of the flow channel 55, on the seal, ensuring a good seal of the whole. This variant, because of the very good seal that it procures, advantageously makes it possible to use the economiser as a water flow interrupter, the control levers of the tap remaining open and the flow then being controlled solely by the impulses exerted on the economiser.

Naturally, in the same way as the variant illustrated, the spherical body of the valve will comprise apertures distributed regularly around the axis of the valve 13 and the rotational driving of the valve 13 takes place in a similar fashion, by the interaction of the teeth with the spring 15.

The teeth 51 of the rotary valve 13 are provided with an inclination, shown in FIGS. 1 and 2. These teeth 51 therefore have an internal face 61 and an external face 63. When an impulse is exerted on the pusher 11, the end 29 of the first arm 21 of the spring 15 is locked in abutment and the internal face 61 of a tooth 51; there is then meshing: the upward translation of this first arm 21 then causes the rotation, about the axis 19, of the valve 13 with respect to the body 17. During this rotation of the valve 13, the end 31 of the second arm 23 of the spring 15 is in abutment on the external face 53 of a tooth 51. The rotation force therefore makes the second arm 23 of the spring 15 slide over the external face 63; this second arm 23 is then retracted towards the outside of the body 17 by pivoting with respect to the pivoting piece 33. This second arm 23 then resumes its idle position by virtue of the elasticity of the spring 15, and positions itself above the internal face 61 of the tooth 51 on which it has just previously slid. It thus provides the non-return function of the valve.

When the first arm 21 of the spring 15 translates, it tends to resume its idle position. The second arm 23 is locked in abutment on the internal face 61 of a tooth 51 and is also locked in the housing 37 of the body 17, which first of all prevents the rotation of the valve 13 in the opposite direction and then prevents the second arm 23 from pivoting with respect to the pivoting piece 33. The end 29 of the first arm 21 of the spring 15 then slides in abutment on the external face 63 of the following tooth 51, the locking of the second arm 23 in the bottom 65 of the housing 37, shown in FIG. 3, then providing the elastic return into the idle position of said first arm 21 below the internal face 61 of this following tooth 51.

With reference to FIGS. 1, 2 and 5, the pusher 11 comprises a recess 67 receiving the end 29 of the first arm 21 of the spring 15. The bottom 69 of the recess 67 bears on the end 29 of this first arm 21 during an impulse or the elastic return into the idle position of the first arm 21. One of the sides of the recess 67, that is to say the internal side 71, provides the locking of the first arm 21 of the spring 15. This locking allows the elastic return into the idle position of the second arm 23 of the spring on the external face 63 of a tooth of the valve 13 after each incrementation of said valve 13. This recess 67 also allows the rotation of the first arm 21 of the spring 15 with respect to the pivoting piece 33 during its elastic return into the idle position after an impulse exerted on the pusher 11.

As shown in FIGS. 1 to 5, the body 17 comprises at least one guide stud 73. This guide stud 73 fits in an orifice 75 on the body 17 and is housed in an aperture 77 on the pusher 11, with which it cooperates in order to provide the translational guidance of said pusher 11 on the body 17 in both directions of the flow axis 9. The top end 79 of the aperture 77 constitutes a stop that delimits the travel of the pusher 11 with respect to the body 17 when it descends under the thrust exerted by the first arm 21 of the spring 15. When a pulse is exerted on the pusher 11, its top end comes into contact on the underside 81 of the body 17 forming a stop.

According to the embodiment shown in FIGS. 1 to 5, the impulse control device comprises a slipring 83 that constitutes an intermediate piece between the body 17 and the pusher 11. This ring 83 is secured to the bottom end 85 of the body 17, for example by screwing. The inside diameter of the pusher 11 receives this ring 83 in order to provide a sliding mounting between these two elements when there is an impulse on the pusher 11 and it returns into position. Preferably, this slipring 83 is designed to receive an aerator or mixer known to persons skilled in the art, breaking up the water jet.

According to a preferential design shown in FIGS. 1 to 5, the impulse control device comprises a protective ring 87. This ring 87 is secured to the body 17 so as to constitute its external envelope. The ring 87 is preferably screwed onto the top end 89 of the body 17 and extends downwards along this in order to cover at least said body 17, the rotary valve 13, the incrementation spring 15 and the top part 91 of the pusher 11 comprising the aperture 77.

The economiser will preferably use seals 93, 95, 97 necessary for ensuring a perfect seal on the assembled elements.

The economiser 1 according to the invention is advantageously manoeuvred by exerting always the same upward impulse on the pusher. The economiser will be used at tap manufacturers and will be usable on any type of standard tap with a male or female thread, by virtue of its adapter. It can be installed very simply by private individuals, who will advantageously be able to reuse the mixer or aerator already equipping their taps.

Finally, it of course goes without saying that the invention is not limited to the embodiment described and that it is possible to produce an impulse economiser involving a needle and a ball closing off the flow channel without departing from the scope of the present invention.

1. Water economiser (1) for mounting on the spout of a tap through which water flows at a rate adjusted when the tap is opened, said economiser comprising a mechanical device for reducing or interrupting the flow, a water inlet pipe (5) mounted on the tap spout, and an outlet pipe (7) through which the water is discharged out of the economiser (1), said inlet (5) and outlet (7) pipes defining a flow axis (9), characterised in that it comprises an impulse control device making it possible, when the tap is opened and when a first impulse is exerted upwards on the outlet pipe (7) along the flow axis (9), to reduce or interrupt the water flow, and then, when a second impulse is exerted upwards on the outlet pipe (7), similar to the first pulse, to re-establish the water flow as initially adjusted.

2. Economiser (1) according to claim 1, characterised in that the impulse control device comprises at least:
a pusher (11) on which the pulses are exerted upwards,
an incrementation rotary valve (13) allowing, according to the incrementation position, either the reduction or interruption of the flow or the flow at the initially adjusted rate,
an incrementation spring (15) for the rotary valve (13) and return of the pusher (11) to its position,
a body (17) for receiving the incrementation spring (15) and the rotary valve (13), said pusher (11) being mounted so as to slide with respect to the body (17) along the flow axis (9).

3. Economiser (1) according to claim 1, characterised in that the incrementation spring (15) is U-shaped, held flat on the body (17) and mounted in pivot connection on said body (17) by means of a pivoting piece (33), the first of the arms (21) of the U undergoing a translation along the orientation of the flow axis (9) when an impulse is exerted on the pusher (11), and the second of the arms (23) of the U undergoing a rotation with a respect to the pivoting piece (33) when the rotary valve (13) is incremented.

4. Economiser (1) according to claim 1, characterised in that the valve (13) comprises a cylindrical central body (49) and teeth (51) for rotationally incrementing said cylindrical body (49) about the axis (19).

5. Economiser (1) according to claim 1, characterised in that the valve (13) comprises a spherical central body and teeth (51) for rotationally incrementing said central body about the axis (19).

6. Economiser (1) according to claim 5, characterised in that the rotary valve (13) comprises at least three apertures (57, 58, 59) disposed in a radial position around the cylindrical or spherical central body (49), said apertures (57, 58, 59) providing either the reduction or interruption of the water flow or normal passage of the water flow, according to the rotational incrementation of the valve (13).

7. Economiser (1) according to claim 4, characterised in that the teeth (51) are provided with an inclination so as to have an internal face (61) and an external face (63), the first arm (21) being locked in abutment on the internal face (61) of a tooth (51) and the second arm (23) sliding in abutment on the external face (63) of a tooth (51) at the time of an impulse, and the second arm (23) being locked in abutment on the internal face (61) of a tooth (51) and the first arm (21) sliding in abutment on the external face (63) of a tooth (51) when said first arm (21) of the spring (15) elastically returns to the idle position.

8. Economiser according to claim 6, characterised in that the body (17) comprises a flow channel (55), comprising an outlet (60) at the bottom part, said flow channel (55) communicating with the cylindrical housing (53) of said body (17) and with the apertures (57, 58, 59) in the rotary valve (13) with the spherical cylindrical body, and in that a seal is positioned at the top periphery of said outlet (60) of the flow channel (55), between the valve body (13) and the housing (53), so as to procure a seal making it possible to use the economiser as a water flow interrupter, leaving the control levers of the tap open.

9. Economiser (1) according to claim 1, characterised in that the impulse device comprises a thread adapter secured to the top end of the body (17), said adapter being fixed to the tap spout.

10. Economiser (1) according to claim 2, characterised in that the incrementation spring (15) is U-shaped, held flat on the body (17) and mounted in pivot connection on said body (17) by means of a pivoting piece (33), the first of the arms (21) of the U undergoing a translation along the orientation of the flow axis (9) when an impulse is exerted on the pusher (11), and the second of the arms (23) of the U undergoing a rotation with a respect to the pivoting piece (33) when the rotary valve (13) is incremented.

11. Economiser (1) according to claim 2, characterised in that the valve (13) comprises a cylindrical central body (49) and teeth (51) for rotationally incrementing said cylindrical body (49) about the axis (19).

12. Economiser (1) according to claim 2, characterised in that the valve (13) comprises a spherical central body and teeth (51) for rotationally incrementing said central body about the axis (19).

13. Economiser (1) according to claim 4, characterised in that the rotary valve (13) comprises at least three apertures (57, 58, 59) disposed in a radial position around the cylindrical or spherical central body (49), said apertures (57, 58, 59) providing either the reduction or interruption of the water flow or normal passage of the water flow, according to the rotational incrementation of the valve (13).

15. Economiser (1) according to claim 5, characterised in that the teeth (51) are provided with an inclination so as to have an internal face (61) and an external face (63), the first arm (21) being locked in abutment on the internal face (61) of a tooth (51) and the second arm (23) sliding in abutment on the external face (63) of a tooth (51) at the time of an impulse, and the second arm (23) being locked in abutment on the internal face (61) of a tooth (51) and the first arm (21) sliding in abutment on the external face (63) of a tooth (51) when said first arm (21) of the spring (15) elastically returns to the idle position.

16. Economiser (1) according to claim 6, characterised in that the teeth (51) are provided with an inclination so as to have an internal face (61) and an external face (63), the first arm (21) being locked in abutment on the internal face (61) of a tooth (51) and the second arm (23) sliding in abutment on the external face (63) of a tooth (51) at the time of an impulse, and the second arm (23) being locked in abutment on the internal face (61) of a tooth (51) and the first arm (21) sliding in abutment on the external face (63) of a tooth (51) when said first arm (21) of the spring (15) elastically returns to the idle position.
